(19) United States
(12) Patent Application Publication
(10) Pub. No.: US 2025/0058433 A1
(43) Pub. Date: Feb. 20, 2025

(54) HYDRAULIC TORQUE WRENCH

(71) Applicant: ATLAS COPCO INDUSTRIAL TECHNIQUE AB, Stockholm (SE)

(72) Inventors: Joseph GILL, Cramlington Northumberland (GB); Tony DODDS, Cramlington Northumberland (GB); Teresa O'BRIEN, Cramlington Northumberland (GB); Ian O'BRIEN, Cramlington Northumberland (GB)

(21) Appl. No.: 18/720,182

(22) PCT Filed: Dec. 14, 2022
(86) PCT No.: PCT/IB2022/062228

§ 371 Date: Jun. 14, 2024

(30) Foreign Application Priority Data
Dec. 15, 2021 (GB) 2118148.2

(51) Int. Cl. B25B 21/00; B25B 23/00; B25B 23/145

(52) U.S. Cl. CPC B25B 21/005; B25B 23/0078; B25B 23/145

(57) ABSTRACT

A hydraulic torque wrench (10), comprising: a head (11), having an input for pressurised hydraulic fluid; a rotatable connector, for connecting to an item to be rotated by the hydraulic torque wrench (10); and a drive mechanism (12), driven by hydraulic fluid introduced at the input and tending to rotate the rotatable connection. A reaction arm (1) mounted on the head (11) through a mounting (16) which selectively allows rotational motion of the reaction arm (1) relative to the head (11) about an axis, the reaction arm (1) arranged to react against a surface when the drive mechanism (12) rotates the rotatable connection. In which the mounting (16) comprises: a splined connection, comprising complementary splines (20) on the head (11) and the reaction arm (1), which permits linear motion of the reaction arm (1) relative to the head (11) along the axis from a first position where the splines (20) of the splined connection interengage so as to prevent relative rotation of the reaction arm (1) and the head (11), and a second position where the splines (20) of the splined connection do not interengage and allow relative rotation of the head (11) and the reaction arm (1); and a rotational travel limiter, which limits relative rotational motion of the reaction arm (1) and the head (11). Reduces likeliness that the reaction arm (1) and head (11) will unexpectedly. unwantedly or undesirably separate.

This invention relates to a hydraulic torque wrench.

Torque wrenches, such as hydraulic torque wrenches, are well known in the prior art and widely used where a torque is to be applied, e.g. to a nut, bolt, or other fastener.

Some hydraulic torque wrenches, such as that disclosed in WO2018/130854, comprise a head containing a drive mechanism driven by hydraulic fluid which drives an item to be rotated, and a reaction arm which provides reactionary support to the torque wrench when it is in operation. For reasons of operational flexibility, it is desirable to be able to change the orientation of the reaction arm relative to the head.

WO2018/130854 discloses a solution in which a splined connection allows the separation of the head and the reaction arm and their reconnection at different angular positions. However, such solutions still present several problems. Firstly, once the head and the reaction arm are separated, there is nothing stopping one part being dropped. Given that hydraulic torque wrenches are often used in situations where work is being carried out at height, such as on wind turbines, this represents a drop hazard, potentially leading to loss of part of the tool and a danger to those positioned below the user, and to any equipment in the path of the falling part. Whilst prior art designs typically contain latches or the like to hold the parts together, it is possible that such latches could fail in use, leading to unexpected separation or unstable tool positioning.

Secondly, with a splined connection, it is possible for a user to connect the two parts in any number of positions, whereas the number of positions in which the tool is desirably going to be operated is much fewer-typically with the reaction arm in line with the head or 90 degrees offset. We have appreciated that it is easy for a user to connect the two parts maybe a spline or two away from a desired position, which leads to an unergonomic usage position, which potentially could be hazardous if that positioning is unstable and the tool moves unexpectedly and unpredictable during use.

According to a first aspect of the invention, we provide a hydraulic torque wrench, comprising:
a head having an input for pressurised hydraulic fluid, a rotatable connector for connecting to an item to be rotated by the hydraulic torque wrench, and a drive mechanism driven by hydraulic fluid introduced at the input and tending to rotate the rotatable connection; and
a reaction arm mounted on the head through a mounting which selectively allows rotational motion of the reaction arm relative to the head about an axis, the reaction arm arranged to react against a surface when the drive mechanism rotates the rotatable connection:
in which the mounting comprises:
a splined connection, comprising complementary splines on the head and the reaction arm, which permits linear motion of the reaction arm relative to the head along the axis from a first position where the splines of the splined connection interengage so as to prevent relative rotation of the reaction arm and the head, and a second position where the splines of the splined connection do not interengage and allow relative rotation of the head and the reaction arm; and
a linear travel limiter which prevents linear motion of the reaction arm relative to the head past the second position and at least one biassing member which acts to bias the reaction arm into the first position.

As such, this represents a hydraulic torque wrench where is it less likely that the reaction arm and head will unexpectedly, unwantedly or undesirably separate. A user will have to act against the bias due to the biassing member to move the reaction arm into the second position, meaning that the reaction arm will tend to remain in the first position where the head and reaction are less likely to separate. If a user unexpectedly releases the reaction arm in the second position, rather than falling off, the reaction arm will tend to return to the first position.

Typically, the biassing member may comprise a spring. The linear travel limiter may comprise at least one bolt having a stud and a head, with the stud of each bolt being fixed relative to one of the head and the reaction arm and working in an aperture in the other of the head and the reaction arm, with the head being too large to fit through the aperture so as to limit the linear travel.

The mounting may further comprise a rotational travel limiter, which may limit relative rotational motion of the reaction arm and the head. Typically, the travel limiter may limit the travel to a range. The range will typically be at most 270, 180 or 90 degrees and may be 90 or 180 degrees. By doing so, the ends of range may represent desired positions of the reaction arm relative to the head (typically a vertical and a horizontal position of the reaction arm, or two 180 degree apart horizontal positions), thus assisting the user in finding those positions. The rotational travel limiter may comprise a protrusion, such as a pin or screw, on one of the head and the reaction arm, working in a slot or groove in the other of the head and the reaction arm, with the slot or groove typically having ends which define the range.

The hydraulic torque wrench may also comprise at least one indicium showing a desired relative rotational location of the reaction arm relative to the head.

The mounting may further comprise a retaining mechanism, which selectively fixes the head and the reaction arm relative to each other when in the first position. This may comprise, for example, a latch or a push-button lock, and may act to fix the complementary splines relative to each other.

According to a second aspect of the invention, we provide a hydraulic torque wrench, comprising:
a head having an input for pressurised hydraulic fluid, a rotatable connector for connecting to an item to be rotated by the hydraulic torque wrench, and a drive mechanism driven by hydraulic fluid introduced at the input and tending to rotate the rotatable connection; and
a reaction arm mounted on the head through a mounting which selectively allows rotational motion of the reaction arm relative to the head about an axis, the reaction arm arranged to react against a surface when the drive mechanism rotates the rotatable connection;
in which the mounting comprises:
a splined connection, comprising complementary splines on the head and the reaction arm, which permits linear motion of the reaction arm relative to the head along the axis from a first position where the splines of the splined connection interengage so as to prevent relative rotation of the reaction arm and the head, and a second position where the splines of the splined connection do not interengage and allow relative rotation of the head and the reaction arm; and
a rotational travel limiter, which limits relative rotational motion of the reaction arm and the head.

By doing so, the limits may represent desired positions of the reaction arm relative to the head (typically a vertical and a horizontal position of the reaction arm, or two 180 degree apart horizontal positions), thus assisting the user in finding those positions.

The hydraulic torque wrench may have any of the optional features of the first aspect of the invention. The mounting may comprise a linear travel limiter which prevents linear motion of the reaction arm relative to the head past the second position. It may also have at least one biassing member which acts to bias the reaction arm into the first position.

According to a third aspect of the invention, there is provided a hydraulic torque wrench, comprising:
a head having an input for pressurised hydraulic fluid, a rotatable connector for connecting to an item to be rotated by the hydraulic torque wrench, and a drive mechanism driven by hydraulic fluid introduced at the input and tending to rotate the rotatable connection; and
a reaction arm mounted on the head through a mounting which selectively allows rotational motion of the reaction arm relative to the head about an axis, the reaction arm arranged to react against a surface when the drive mechanism rotates the rotatable connection;
in which the mounting comprises:
a splined connection, comprising complementary splines on the head and the reaction arm, which permits linear motion of the reaction arm relative to the head along the axis from a first position where the splines of the splined connection interengage so as to prevent relative rotation of the reaction arm and the head, and a second position where the splines of the splined connection do not interengage and allow relative rotation of the head and the reaction arm; and
a linear travel limiter which prevents linear motion of the reaction arm relative to the head past the second position, comprising a rigid elongate member attached to the head, with a step on the reaction arm engaging a stop on the rigid elongate member to stop the linear motion past the second position.

Typically, the rigid elongate member will work in a bore in the reaction arm; the bore and the rigid elongate member may each have a length, with the bore having a diameter and the rigid elongate member having a width. The diameter and the width may vary along the lengths, and may both be perpendicular to the lengths. The step may comprise a change in diameter of the bore, whereas the stop may comprise a part of the rigid elongate member that is wider than the rest of the rigid elongate member.

Typically, the rigid elongate member may comprise a bolt secured to the head, with the part of the rigid elongate member that is wider than the rest of the rigid elongate member forming a head of the bolt.

The splines on the head may be provided on a cylindrical boss extending from a base on the head outwards. The rigid elongate member may be attached to the head at or adjacent to the base.

This arrangement is secure and easy to manufacture.

The hydraulic torque wrench may have any of the optional features of the first or second aspects of the invention. The mounting may comprise a rotational travel limiter, which limits relative rotational motion of the reaction arm and the head. It may also have at least one biassing member which acts to bias the reaction arm into the first position. There now follows, by way of example only, description of an embodiment of the invention, described with reference to the accompanying drawings, in which:

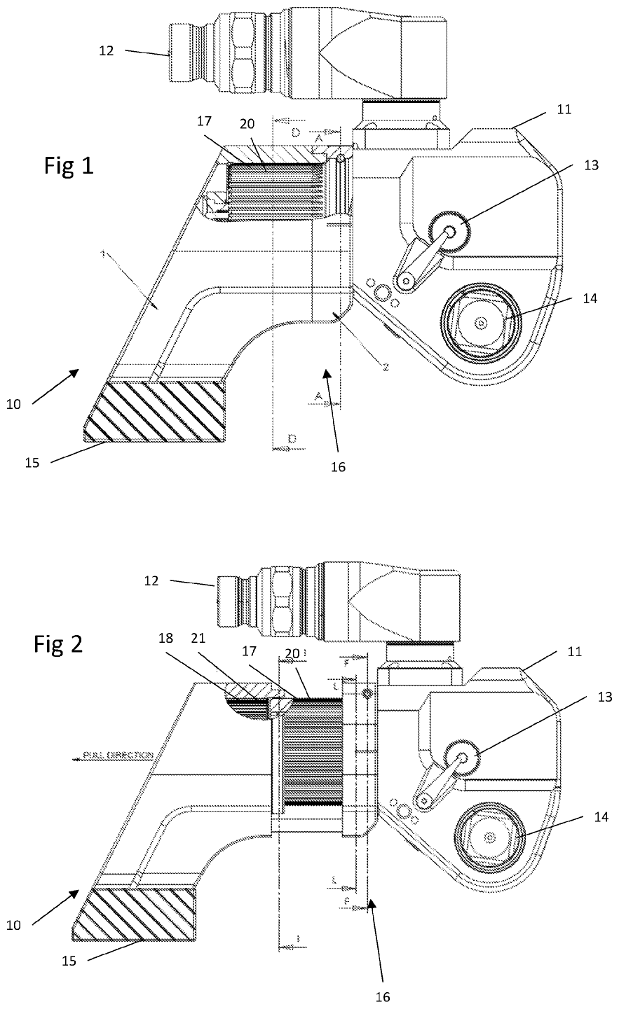

FIGS. 1 to 4 show a side elevation of a hydraulic torque wrench in accordance with an embodiment of the invention, in first to fourth positions respectively:

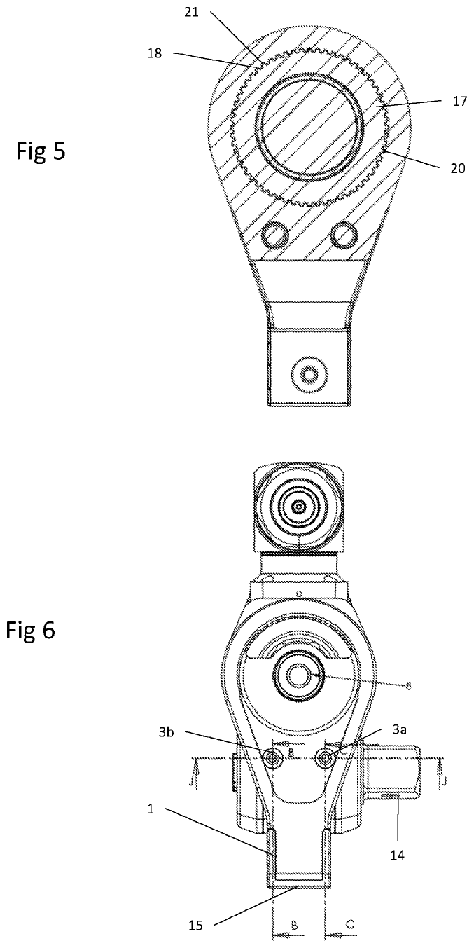

FIG. 5 shows a cross section along line D-D in FIG. 1;

FIG. 6 shows a rear elevation of the hydraulic torque wrench of FIG. 1, in the first position;

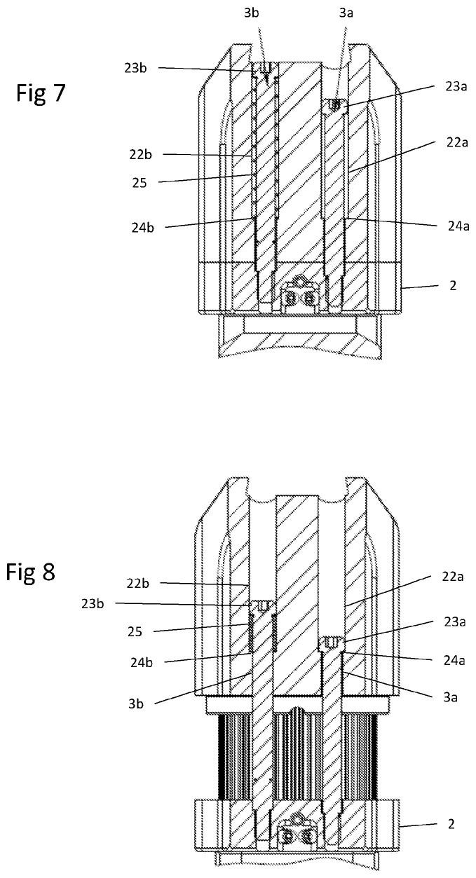

FIG. 7 shows a cross section along line J-J in FIG. 6;

FIG. 8 shows the same cross section as in FIG. 6, but with the torque wrench in the second position as shown in FIG. 2;

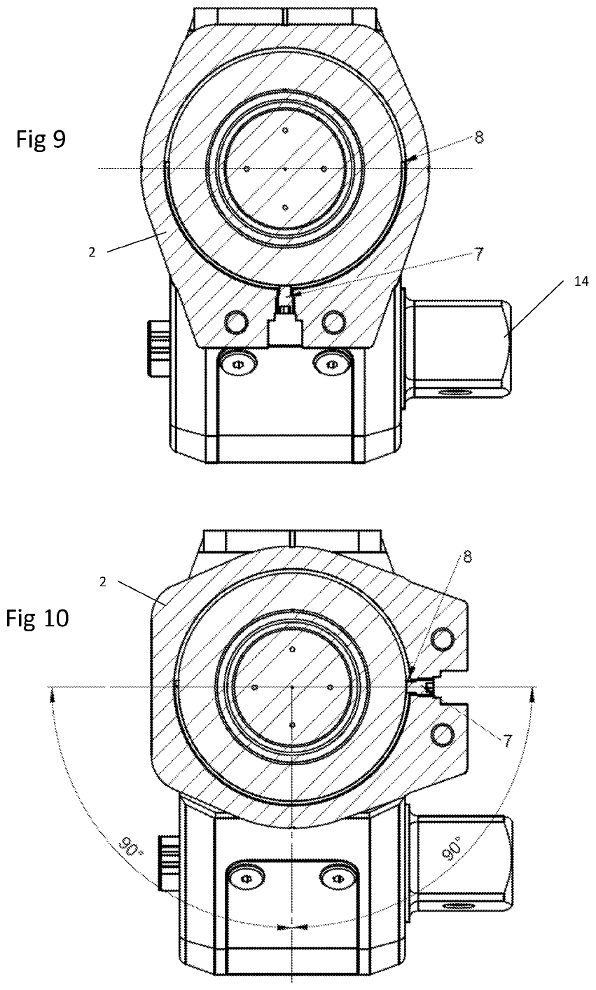

FIG. 9 shows a cross section along line L-L in FIG. 2;

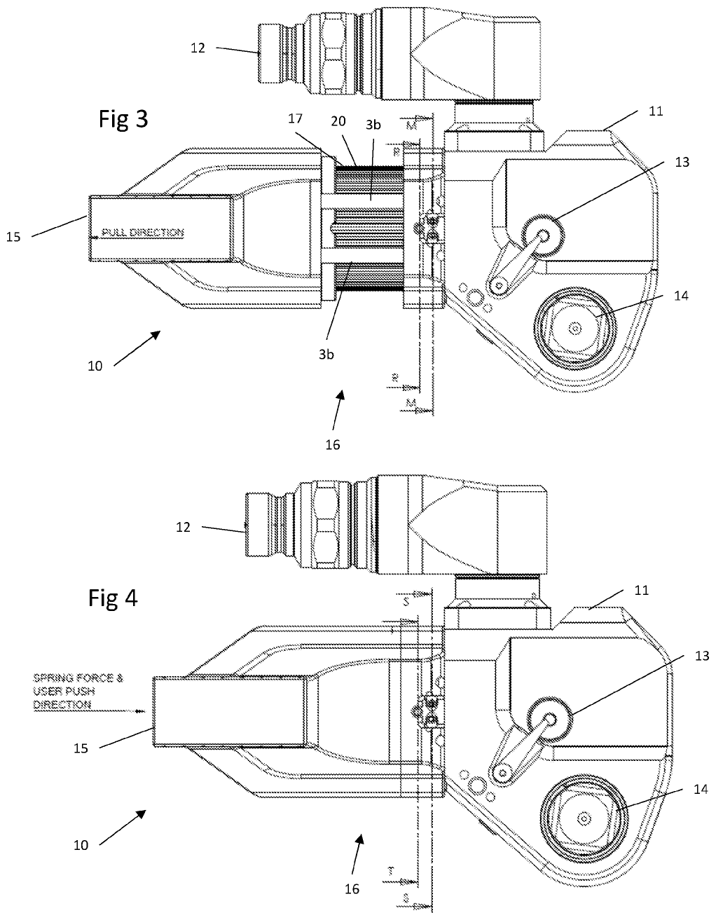

FIG. 10 shows the same cross section as in FIG. 9, but with the torque wrench in the third position shown in FIG. 3;

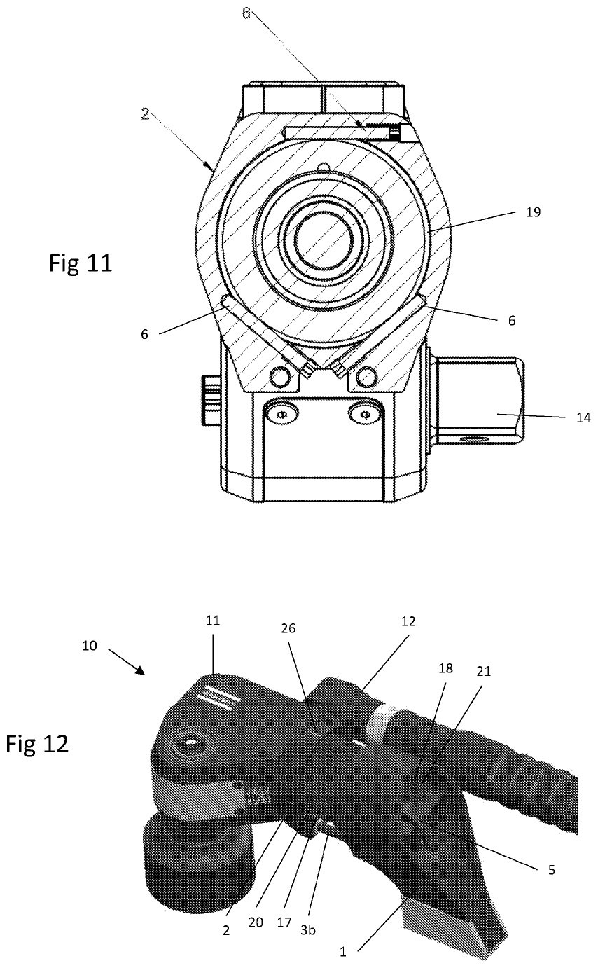

FIG. 11 shows a cross section along line A-A in FIG. 1; and

FIG. 12 shows a perspective view of the hydraulic torque wrench of FIG. 1.

A hydraulic torque wrench 10 is shown in the accompanying drawings. The wrench 10 comprises a head 11, which has a port 12 for hydraulic fluid. The head 11 contains a drive mechanism (largely internal, but indicated at 13) which uses the pressure of pressurised hydraulic fluid at port 12 to rotate square drive 14. This is then connected to an item to be rotated (e.g. a nut via a socket).

The hydraulic torque wrench 10 also comprises a reaction arm 1. This is used to support the hydraulic torque wrench against reaction forces when rotating the item to be rotated. Typically, the arm's reaction surface 15 is placed against a convenient surface so that the reaction surface 15 can support the hydraulic torque wrench against it.

The reaction arm 1 is mounted on the head 11 through a mounting 16. This comprises a splined cylindrical member 17 having splines 20 extending from the head 11 engaging a complementarily splined bore 18 having splines 21 in the reaction arm 1. With the two sets of splines 20, 21 engaged as in the first position of the hydraulic torque wrench shown in FIG. 1, it is not possible to rotate the reaction arm 1 relative to the head 11.

The mounting further comprises an anchor 2. As can be seen in FIG. 11 of the accompanying drawings, three dowel screws 6 in the anchor 2 are positioned tangentially to a circumferential groove 19 on an unsplined part of the cylindrical member 17. This allows the anchor 2 to rotate (subject to the effects of the splines 20, 21) but not move linearly relative to the head 11.

Two elongate, rigid bolts 3a, 3b are secured to the anchor but pass through bores 22a, 22b in the reaction arm 1. Each bolt 3a, 3b has a head 23a, 23b; the bores 22a, 22b are wider than the heads 23a, 23b but have a step decrease in diameter 24a, 24b.

Bolt 3a is shorter; as such, should the reaction arm 1 be withdrawn linearly from the head 11 from the first position of FIGS. 1 and 7 to the second position of FIGS. 2 and 8, the head 23a of bolt 3a will meet the step 24a and stop any further travel as has happened in FIGS. 2 and 8. This stop on linear motion correspond with the splines 20, 21 being disengaged.

Bolt 3b is longer, but has a compression spring 25 working in the bore between step 24b and head 23b. As such, this spring 25 will act to bias the splines 20, 21 into engagement and to bring the mounting into the first position of FIG. 1.

Thus, if a user wishes to change the position of the reaction arm 1, then starting from the first, use position shown in FIG. 1, they will draw back the reaction arm 1 against the force of spring 25 so as to disengage the splines 20, 21. Thus, the wrench is now in the second position as shown in FIG. 2.

The user can now rotate the reaction arm 1 relative to the head 11. However, there is a circumferential groove 8 on cylindrical member 17, the groove 8 extending slightly more than 180 degrees around the circumference of the cylindrical member 11. A screw 7 in the anchor 2 extends into this groove 8. As such, the screw will limit the rotational travel of the reaction arm 1 relative to the head 11; allowing for the diameter of the screw, the rotational travel will be limited to 180 degrees. The ends of groove 8 represent commonly-used positions where the reaction arm 1 extends perpendicularly to the head 11, one of which is shown in FIGS. 3 and 4; the midpoint of the groove 8 represents another commonly-used position (shown in FIGS. 1 and 2 of the drawings) where the reaction arm 1 is in line with the head 11.

This limit on rotational movement of the reaction arm 1 relative to the head 11 allows a user to easily find two of the most commonly-used positions: they are much less likely to commit an error of being one or two spline-spacings away from the desired position, leading to a more reliable installation of the wrench.

The midpoint position of FIG. 1 may be indicated by an indicium 26 carried on the anchor 2 as shown in FIG. 12 of the accompanying drawings, thus allowing the user to easily find this other commonly-used position.

As such, the user has now selected their desired new alignment of reaction arm 1 and head 11, with the wrench in the third position shown in FIG. 3 of the accompanying drawings. The user can then allow the force from spring 25, and their own applied force, to guide the splines 20, 21 back into engagement so that the wrench is in the fourth position shown in FIG. 4. There is provided a push-button lock 5 which holds the reaction arm 1 and head 11 in place relative to each other; the user will then activate this and the wrench is ready for use. Even if this lock 5 were to fail or to be accidentally disengaged, the wrench will tend to stay in the engaged position due to the biassing force of spring 25 and the limit on travel due to bolt 3a, rather than potentially falling apart as potentially is possible with prior art devices.

1. A hydraulic torque wrench, comprising:
a head having an input for pressurised hydraulic fluid, a rotatable connector for connecting to an item to be rotated by the hydraulic torque wrench, and a drive mechanism driven by hydraulic fluid introduced at the input and tending to rotate the rotatable connection; and
a reaction arm mounted on the head through a mounting which selectively allows rotational motion of the reaction arm relative to the head about an axis, the reaction arm arranged to react against a surface when the drive mechanism rotates the rotatable connection;
in which the mounting comprises:
a splined connection, comprising complementary splines on the head and the reaction arm, which permits linear motion of the reaction arm relative to the head along the axis from a first position where the splines of the splined connection interengage so as to prevent relative rotation of the reaction arm and the head, and a second position where the splines of the splined connection do not interengage and allow relative rotation of the head and the reaction arm; and
a rotational travel limiter, which limits relative rotational motion of the reaction arm and the head.

2. A hydraulic torque wrench, comprising:
a head having an input for pressurised hydraulic fluid, a rotatable connector for connecting to an item to be rotated by the hydraulic torque wrench, and a drive mechanism driven by hydraulic fluid introduced at the input and tending to rotate the rotatable connection; and
a reaction arm mounted on the head through a mounting which selectively allows rotational motion of the reaction arm relative to the head about an axis, the reaction arm arranged to react against a surface when the drive mechanism rotates the rotatable connection;
in which the mounting comprises:
a splined connection, comprising complementary splines on the head and the reaction arm, which permits linear motion of the reaction arm relative to the head along the axis from a first position where the splines of the splined connection interengage so as to prevent relative rotation of the reaction arm and the head, and a second position where the splines of the splined connection do not interengage and allow relative rotation of the head and the reaction arm; and
a linear travel limiter which prevents linear motion of the reaction arm relative to the head past the second position, comprising a rigid elongate member attached to the head, with a step on the reaction arm engaging a stop on the rigid elongate member to stop the linear motion past the second position.

3. A hydraulic torque wrench, comprising:
a head having an input for pressurised hydraulic fluid, a rotatable connector for connecting to an item to be rotated by the hydraulic torque wrench, and a drive mechanism driven by hydraulic fluid introduced at the input and tending to rotate the rotatable connection; and
a reaction arm mounted on the head through a mounting which selectively allows rotational motion of the reaction arm relative to the head about an axis, the reaction arm arranged to react against a surface when the drive mechanism rotates the rotatable connection;
in which the mounting comprises:
a splined connection, comprising complementary splines on the head and the reaction arm, which permits linear motion of the reaction arm relative to the head along the axis from a first position where the splines of the splined connection interengage so as to prevent relative rotation of the reaction arm and the head, and a second position where the splines of the splined connection do not interengage and allow relative rotation of the head and the reaction arm; and
a linear travel limiter which prevents linear motion of the reaction arm relative to the head past the second position and at least one biassing member which acts to bias the reaction arm into the first position.

4. The hydraulic torque wrench of claim 1, in which the mounting comprises a linear travel limiter which prevents linear motion of the reaction arm relative to the head past the second position.

5. The hydraulic torque wrench of claim 4, in which the mounting has at least one biassing member which acts to bias the reaction arm into the first position.

6. The hydraulic torque wrench of claim 2, in which the mounting comprises a rotational travel limiter, which limits relative rotational motion of the reaction arm and the head.

7. The hydraulic torque wrench of claim 3, in which the linear travel limiter comprises at least one bolt having a stud and a head, with the stud of each bolt being fixed relative to one of the head and the reaction arm and working in an aperture in the other of the head and the reaction arm, with the head being too large to fit through the aperture so as to limit the linear travel.

8. The hydraulic torque wrench of claims 1, in which the rotational travel limiter limits the travel to a range.

9. The hydraulic torque wrench of claim 8, in which the range is at most 180 degrees.

10. The hydraulic torque wrench of claim 9, in which the range is 90 or 180 degrees.

11. The hydraulic torque wrench of claim 8, in which the ends of range represent desired positions of the reaction arm relative to the head.

12. The hydraulic torque wrench of claim 1, in which the rotational travel limiter comprises a protrusion on one of the head and the reaction arm, working in a slot or groove or groove in the other of the head and the reaction arm, with the slot or groove typically having ends which define the range.

13. The hydraulic torque wrench of claim 1, comprising at least one indicium showing a desired relative rotational location of the reaction arm relative to the head.

14. The hydraulic torque wrench of claim 1, comprising a retaining mechanism, which selectively fixes the head and the reaction arm relative to each other when in the first position.

15. The hydraulic torque wrench of claim 1, in which the rigid elongate member works in a bore in the reaction arm; the bore and the rigid elongate member each have a length, with the bore having a diameter and the rigid elongate member having a width,
in which the step comprises a change in diameter of the bore, and the stop comprises a part of the rigid elongate member that is wider than the rest of the rigid elongate member.

16. The hydraulic torque wrench of claim 15, in which the splines on the head are provided on a cylindrical boss extending from a base on the head outwards, in which the rigid elongate member is attached to the head at or adjacent to the base.

17. The hydraulic torque wrench of claim 3, in which the mounting comprises a rotational travel limiter, which limits relative rotational motion of the reaction arm and the head.
